(19) United States
(12) Patent Application Publication
(10) Pub. No.: US 2025/0351249 A1
(43) Pub. Date: Nov. 13, 2025

(54) DETECTION DEVICE AND LIGHTING SYSTEM

(71) Applicant: Panasonic Intellectual Property Management Co., Ltd., Osaka (JP)

(72) Inventors: Shigeo GOTOH, Osaka (JP); Tomomi HASHIMOTO, Kyoto (JP)

(21) Appl. No.: 19/174,585

(22) Filed: Apr. 9, 2025

(30) Foreign Application Priority Data
May 10, 2024 (JP) 2024-077526

(51) Int. Cl. H05B 47/13; F21V 23/04; G01J 5/00; H05B 47/11

(52) U.S. Cl. CPC H05B 47/13; F21V 23/0471; G01J 5/0025; H05B 47/11

(57) ABSTRACT

The detection device includes: a human detector that detects movement of a person; a communicator that transmits a detection signal indicating that the human detector has detected the movement of the person; and a controller that delays or prunes transmission of the detection signal by the communicator when the controller determines that a magnitude of the movement of the person detected by the human detector is less than a predetermined magnitude.

### CROSS REFERENCE TO RELATED APPLICATION

This application claims the benefit of priority of Japanese Patent Application Number 2024-077526, filed on May 10, 2024, the entire content of which is hereby incorporated by reference.

### TECHNICAL FIELD

The present disclosure relates to a detection device and a lighting system.

### BACKGROUND ART

A lighting fixture whose light emission is controlled only when a person is present by wirelessly communicating with a sensor when the sensor detects a person has been disclosed (for example, see Japanese Unexamined Patent Application Publication No. 2023-067956 (Patent Literature (PTL) 1)).

### SUMMARY

However, according to the technique disclosed in PTL 1, for example, when a plurality of sensors are provided in an indoor space, a detection signal is transmitted every time movement of a person is detected, which increases the number of times the detection signal is transmitted. In such a situation, there is a problem that the detection signal sometimes cannot be transmitted to a target device even though the sensor detects a person, due to congestion in the communication for transmitting the detection signal.

In view of this, an object of the present disclosure is to provide a detection device and a lighting system that more reliably transmit a detection signal to a device.

An aspect of a detection device according to the present disclosure includes: a human detector that detects movement of a person; a communicator that transmits a detection signal indicating that the human detector has detected the movement of the person; and a controller that delays or prunes transmission of the detection signal by the communicator when the controller determines that a magnitude of the movement of the person detected by the human detector is less than a predetermined magnitude.

Moreover, an aspect of a lighting system according to the present disclosure includes: the detection device described above; and a lighting fixture that is controlled based on the detection signal transmitted by the detection device.

The detection device and the lighting system according to the present disclosure can more reliably transmit a detection signal to a device.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram illustrating a functional configuration of a lighting system according to an embodiment.

FIG. 2 is a diagram illustrating an example of an arrangement of detection devices and lighting fixtures in the lighting system according to the embodiment.

FIG. 3 is a flowchart illustrating operation of a detection device according to the embodiment.

FIG. 4 is a diagram illustrating how the detection device according to the embodiment operates.

FIG. 5 is a flowchart illustrating operation of a detection device according to Variation 1 of the embodiment.

FIG. 6 is a diagram illustrating how the detection device according to Variation 1 of the embodiment operates.

### DETAILED DESCRIPTION

Hereinafter, one or more embodiments of the detection device and the lighting system according to the present disclosure will be described in detail with reference to the drawings. Note that each of the one or more embodiments described below illustrates a specific example of the present disclosure. The numerical values, structural elements, the arrangement and connection of the structural elements etc. shown in the following one or more embodiments are mere examples, and therefore are not intended to limit the present disclosure. In addition, among the structural elements in the following one or more embodiments, structural elements not recited in any one of the independent claims are described as optional structural elements.

Note that the figures are schematic illustrations and are not necessarily depictions. Moreover, in the figures, configurations that are essentially the same share like reference signs, and overlapping description may be omitted or simplified.

### Embodiment

### Configuration

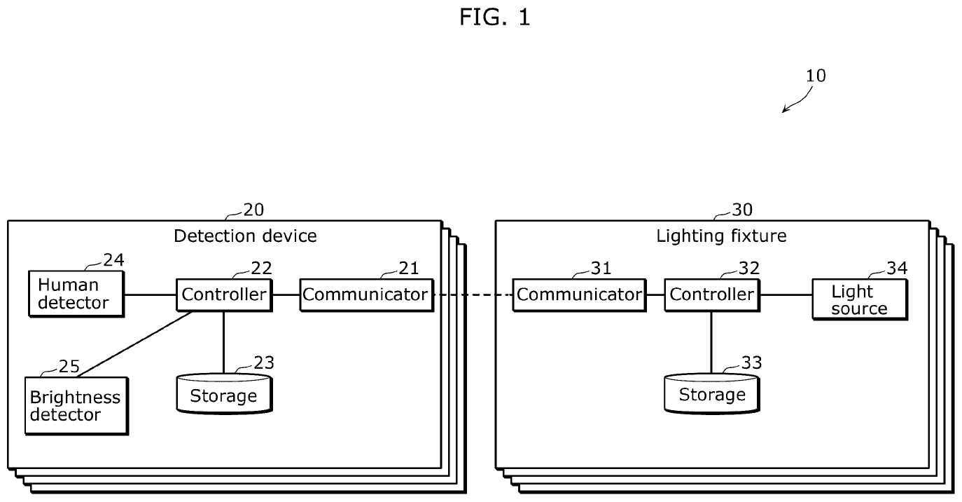

First, the configuration of a lighting system according to an embodiment will be described. FIG. 1 is a block diagram illustrating a functional configuration of lighting system 10 according to the embodiment.

Lighting system 10 is a system for illuminating an indoor space. The indoor space is, for example, an office. A user of lighting system 10 is, for example, a person who works in an office where lighting system 10 is provided. Lighting system 10 includes a plurality of detection devices 20 and a plurality of lighting fixtures 30. Any number of detection devices 20 and lighting fixtures 30 may be included in lighting system 10.

Each of detection devices 20 has a function of transmitting a detection signal to a device. Detection device 20 may be implemented by, for example, a human presence sensor. Detection device 20 may include an illuminance sensor. Specifically, detection device 20 includes communicator 21, controller 22, storage 23, human detector 24, and brightness detector 25.

Communicator 21 is a communication circuit (communication module) for detection device 20 to transmit a detection signal to lighting fixture 30. Communication performed by communicator 21 is, for example, wireless communication in accordance with communication standards such as Bluetooth (registered trademark) Low Energy (BLE), Wi-Fi (registered trademark), or Zigbee (registered trademark), but may be wired communication.

Controller 22 performs, for example, information processing for transmitting the detection signal. Controller 22 adjusts a transmission timing of the detection signal. Controller 22 may be implemented by, for example, a microcomputer, but may be implemented by a processor or a dedicated circuit.

Storage 23 is a storage device in which a computer program to be executed by controller 22, and the like, are stored. Storage 23 may be implemented by, for example, semiconductor memory.

Human detector 24 determines whether a person is present in a detection range of detection device 20. For example, human detector 24 may be implemented by, for example, a pyroelectric sensor (infrared sensor) that detects infrared radiation emitted from a body of a person, and in particular, a passive infrared (PIR) sensor that passively detects infrared radiation emitted from a body of a person. When human detector 24 is a pyroelectric sensor, human detector 24 determines the presence of a person by detecting movement of the person. Human detector 24 may be implemented by an image sensor (camera) that captures an image of the indoor space. Moreover, human detector 24 may be implemented by a radio wave sensor. Human detector 24 may be any sensor as long as it is a sensor capable of detecting the magnitude of movement.

Brightness detector 25 determines the brightness in the detection range of detection device 20. Brightness detector 25 is implemented by, for example, an illuminance sensor.

Lighting fixture 30 is provided on the ceiling of the indoor space to illuminate the indoor space. Lighting fixture 30 may be implemented by, for example, a base light. Lighting fixture 30 is not particularly limited to this aspect. Lighting fixture 30 may be a ceiling light, a downlight, a spotlight, or the like. Specifically, lighting fixture 30 includes communicator 31, controller 32, storage 33, and light source 34.

Communicator 31 is a communication circuit (communication module) for lighting fixture 30 for communicating with detection device 20. Communication performed by communicator 31 is, for example, wireless communication in accordance with communication standards such as BLE, Wi-Fi (registered trademark), or Zigbee (registered trademark), but may be wired communication. Communicator 31 may perform wired communication with one detection device 20 and wireless communication with the other detection devices 20. The communication standard for communication performed by communicator 31 may be any communication standard.

Controller 32 controls light emission of lighting fixture 30 (light source 34). Light emission control includes, for example, turn-on control, turn-off control, dimming control, color control, light distribution control, and the like. Controller 32 may be implemented by, for example, a microcomputer, but may be implemented by a processor or a dedicated circuit. The function of controller 32 is implemented by executing a computer program (software) stored in storage 33 by hardware such as the microcomputer or processor that is included in controller 32.

Storage 33 is a storage device in which a computer program to be executed by controller 32, and the like, are stored. Storage 33 may be implemented by, for example, semiconductor memory.

Light source 34 emits white light to the indoor space to illuminate the indoor space by lighting fixture 30. Light source 34 is implemented by, for example, a light-emitting diode (LED) element, but may be implemented by other light-emitting elements such as a semiconductor laser element, an organic or inorganic electro-luminescence (EL) element, etc.

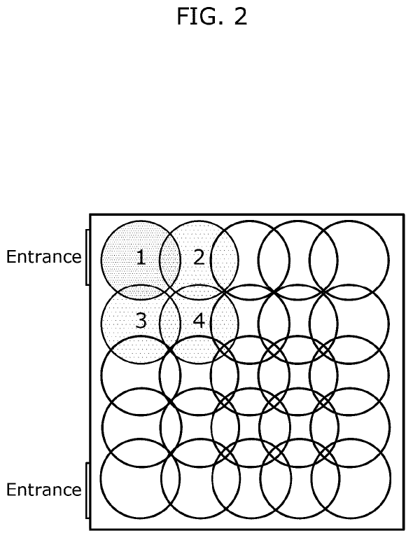

Next, an arrangement of the plurality of detection devices 20 and the plurality of lighting fixtures 30 in lighting system 10 will be described. FIG. 2 is a diagram illustrating an example of an arrangement of detection devices 20 and lighting fixtures 30 in lighting system 10 according to the embodiment. In FIG. 2, the large square frame represents the indoor space in which lighting system 10 is provided, and each of the circles drawn within the square frame represents a specific area.

As illustrated in FIG. 2, the indoor space is divided into a plurality of areas. For example, a pair of detection device 20 and lighting fixture 30 are provided for each area. More specifically, in FIG. 2, the indoor space is divided into 25 areas. For example, in the area indicated by “1”, one detection device 20 performs sensing one lighting fixture 30 emits light.

Note that, a plurality of detection devices 20 may be provided for one area, and a plurality of lighting fixtures 30 may be provided for one area. As long as a target area where detection device 20 performs detection is associated with a target area where lighting fixture 30 illuminates, any number of detection devices 20 and lighting fixtures 30 may be used.

Note that the areas may partially overlap. In other words, a certain portion of the indoor space may be included in two or more areas.

Lighting fixture 30 provided to illuminate a certain area basically emits light to the area upon receipt of a detection signal indicating that detection device 20 provided to perform detection in the area has detected a person, from detection device 20.

Note that, the area where detection device 20 performs detection is associated with the area where lighting fixture 30 illuminates do not have to be the same range. For example, in an exhibition space, lighting fixture 30 may emit light to the exhibition space based on a detection signal indicating that detection device 20 provided to perform detection in an area adjacent to the exhibition space has detected a person.

### Operation

Next, operation of detection device 20 according to the embodiment will be described. With the conventional detection device, for example, when a plurality of detection devices are provided in an indoor space and a detection signal is transmitted each time movement of a person is detected, the total number of detection signal transmissions increases, and the communication for transmitting the detection signal becomes congested. This may result in the detection signal not being transmitted to a target device even though a detection device detects a person.

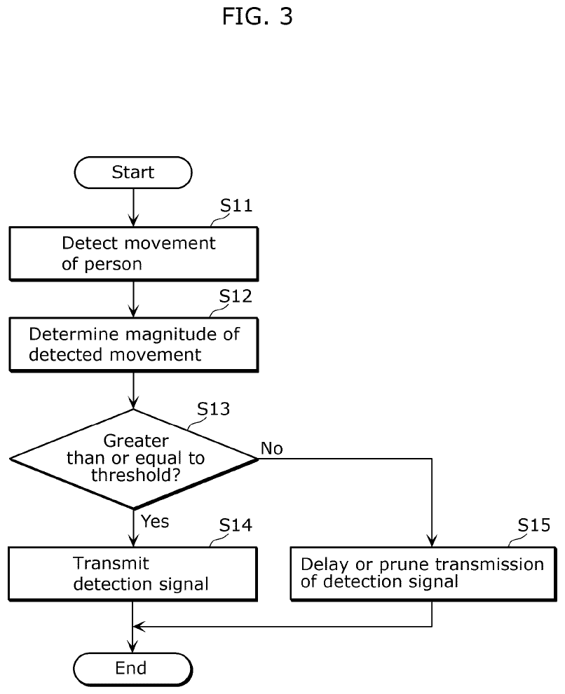

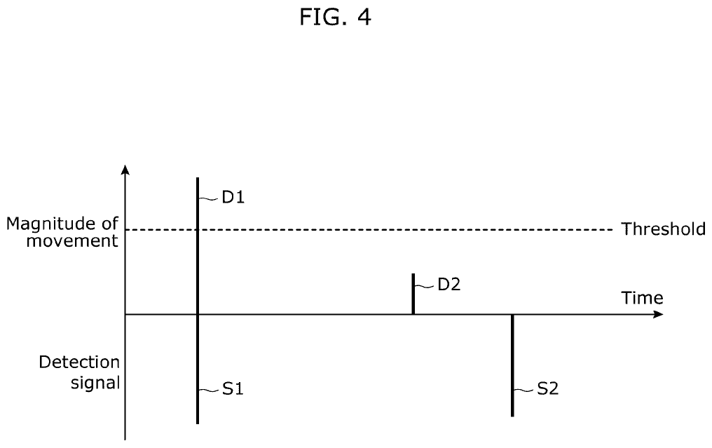

When detection device 20 according to the embodiment detects movement of a person, detection device 20 determines the magnitude of the movement of the person. When detection device 20 determines that the magnitude of the movement is less than or equal to a threshold, detection device 20 delays or prunes the transmission of the detection signal. With such operation, detection device 20 can more reliably transmit the detection signal to a device. The following describes such operation of detection device 20. FIG. 3 is a flowchart illustrating operation of detection device 20 according to the embodiment. FIG. 4 is a diagram illustrating how detection device 20 according to the embodiment operates.

First, human detector 24 of detection device 20 detects movement of a person (S11 in FIG. 3). Here, movement of a person includes not only movement that occurs when a person is walking in a target space where human detector 24 performs detection, but also a relatively small movement that occurs when a person is working while sitting in the target space.

When human detector 24 detects movement of a person, controller 22 determines whether the magnitude of the detected movement of the person is greater than or equal to the threshold (S12 in FIG. 3). The magnitude of the detected movement of the person being greater than or equal to the threshold indicates that the movement of the person is large enough to be determined as walking of a person.

Here, an example of how to determine the magnitude of movement of a person will be described. For example, human detector 24 is implemented by a pyroelectric infrared sensor. When infrared radiation is incident on the pyroelectric infrared sensor, a temperature change occurs and the surface temperature of the pyroelectric element increases, and surface charge is generated by the pyroelectric effect. An analog signal is output by processing the generated surface charge. In other words, more surface charge is generated as the temperature change becomes larger, and the intensity of the analog signal becomes stronger as more surface charge is generated. Therefore, by setting a first threshold and a second threshold lower than the first threshold for the intensity of the analog signal, human detector 24 can distinguish between a first digital detection signal that is output when the intensity of the analog signal is greater than or equal to the first threshold and a second digital detection signal that is output when the intensity of the analog signal is greater than or equal to the second threshold and less than the first threshold, and outputs one of the first digital detection signal or the second digital detection signal.

When the digital signal output by human detector 24 is the first digital detection signal, controller 22 determines that the magnitude of the detected movement of the person is greater than or equal to the threshold. When the digital signal output by human detector 24 is the second digital detection signal, controller 22 determines that the magnitude of the detected movement of the person is less than the threshold.

Moreover, controller 22 may determine the magnitude of movement of a person based on the duration in which the digital signals are output by human detector 24. When human detector 24 detects movement of a person with a magnitude greater than or equal to the threshold, for example, a person walking in a target area, digital signals are continuously output for a relatively long period. When human detector 24 detects movement of a person with a magnitude less than the threshold, for example, a person is moving his/her hands in the target area, digital signals are continuously output for a relatively short period. Therefore, when the duration in which the digital signals are output by human detector 24 is longer than or equal to a predetermined period, controller 22 may determine that the magnitude of the detected movement of the person is greater than or equal to the threshold. When the duration in which the digital signals are output by human detector 24 is shorter than the predetermined period, controller 22 may determine that the magnitude of the detected movement of the person is less than the threshold.

When the magnitude of the detected movement of the person is determined to be greater than or equal to the threshold (Yes in S13 in FIG. 3), controller 22 transmits the detection signal through communicator 21 (S14 in FIG. 3). When lighting fixture 30 receives the detection signal through communicator 31, controller 32 controls light source 34 based on the program stored in storage 33. For example, controller 32 controls light source 34 to be in a bright dimming state upon receipt of the detection signal.

Detection D1 in FIG. 4 indicates that a given detection device 20 has detected movement of a person with a magnitude greater than or equal to the threshold. At this time, as illustrated in FIG. 4, detection signal S1, which notifies one or more of the other devices that detection D1 is performed, is transmitted immediately after detection D1.

When the magnitude of the detected movement of the person is determined to be less than the threshold (No in S13), controller 22 delays or prunes the transmission of the detection signal to be transmitted through communicator 21 (S15).

Delaying transmission of a detection signal refers to when controller 22 transmits the detection signal after a predetermined time has elapsed from a time at which controller 22 obtains the second digital detection signal from human detector 24. The delaying transmission of the detection signal does not occur naturally in normal operation, but rather delaying the timing of the transmission of the detection signal for a predetermined period than in the normal operation. The predetermined period may be, for example, 3 seconds, but may be 5 seconds or 10 seconds. The predetermined period may be of any length.

Pruning the transmission of detection signals refers to when controller 22 temporarily suspends transmission, which results in a lower frequency of detection signal transmission. For example, controller 22 transmits a detection signal only once for every two times controller 22 obtains the second digital detection signal from human detector 24. Note that controller 22 may transmit a detection signal only once for every three times controller 22 obtains the second digital detection signal, or transmit a detection signal only twice for every three times controller 22 obtains the second digital detection signal. Here, the frequency of detection signal transmission may be reduced in any manner.

Detection D2 in FIG. 4 indicates that detection device 20 has detected movement of a person with a magnitude less than the threshold. At this time, as illustrated in FIG. 4, detection signal S2 is transmitted after a predetermined period has elapsed from detection D2.

With the operation described above, when detection device 20 detects movement of a person, detection device 20 determines the magnitude of the movement of the person. When detection device 20 determines that the magnitude of the movement is less than or equal to a threshold, detection device 20 delays or prunes the transmission of the detection signal. Accordingly, detection device 20 can inhibit congestion of communication for transmitting the detection signal. With this, detection device 20 can more reliably transmit the detection signal to lighting fixture 30.

### Variation 1

Detection device 20 may further include brightness detector 25, and may delay or prune transmission of the detection signal according to the brightness detected by brightness detector 25. In other words, when the brightness of a space where detection device 20 is provided is greater than or equal to the brightness threshold, the transmission of the detection signal indicating that a person is detected in the space may be delayed or pruned. This is because when the space is sufficiently bright, a user is unlikely to feel inconvenience even though the detection signal is not transmitted immediately and lighting fixture 30 is not immediately controlled to be in a brightly illuminated state.

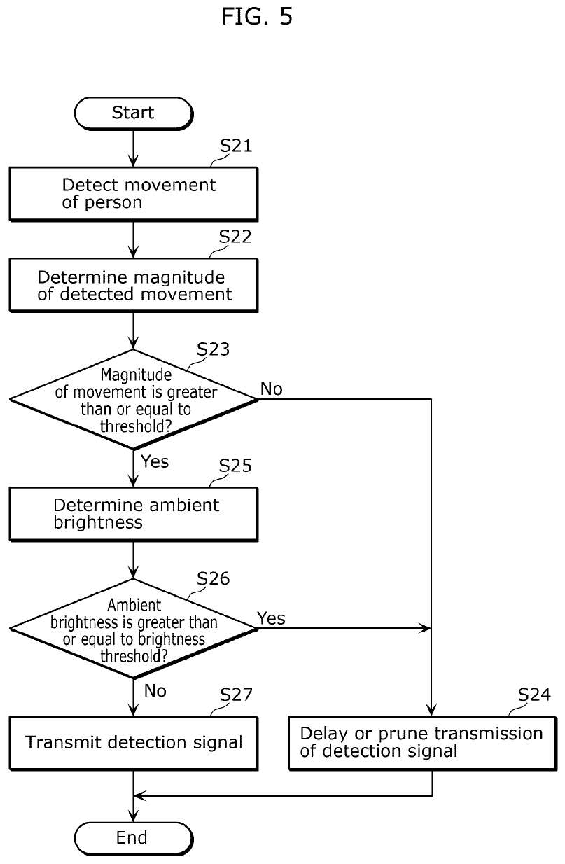

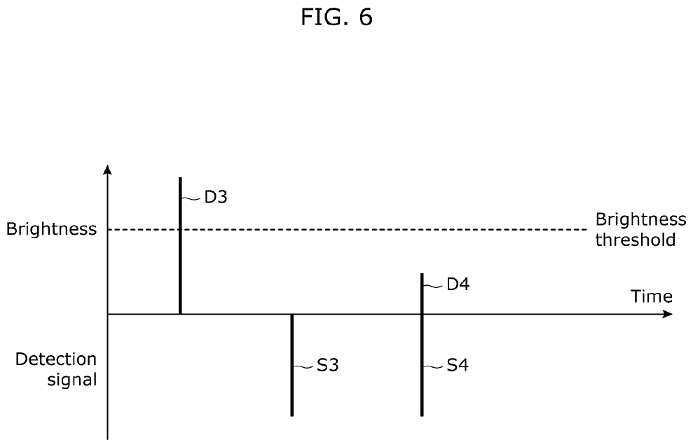

Operation of such detection device 20 according to Variation 1 will be described. FIG. 5 is a flowchart illustrating operation of detection device 20 according to Variation 1 of the embodiment. FIG. 6 is a diagram illustrating how detection device 20 according to Variation 1 of the embodiment operates.

First, human detector 24 of detection device 20 detects movement of a person (S21 in FIG. 5). When human detector 24 detects movement of a person, controller 22 determines whether the magnitude of the detected movement of the person is greater than or equal to the threshold (S22 in FIG. 5).

When the magnitude of the detected movement of the person is determined to be less than the threshold (No in S23 in FIG. 5), controller 22 delays or prunes the transmission of the detection signal to be transmitted through communicator 21 (S24 in FIG. 5).

When the magnitude of the detected movement of the person is determined to be greater than or equal to the threshold (Yes in S23 in FIG. 5), controller 22 determines whether the brightness detected by brightness detector 25 is greater than or equal to a brightness threshold (S25 in FIG. 5). Controller 22 obtains, from brightness detector 25, information indicating the ambient brightness detected by brightness detector 25, and determines whether the ambient brightness is greater than or equal to the brightness threshold.

When the ambient brightness is determined to be greater than or equal to the brightness threshold (Yes in S26 in FIG. 5), controller 22 delays or prunes the transmission of the detection signal to be transmitted through communicator 21 (S24 in FIG. 5).

Detection D3 in FIG. 6 indicates that the ambient brightness detected by brightness detector 25 is greater than or equal to the brightness threshold, when human detector 24 of detection device 20 has detected movement of a person with a magnitude greater than or equal to the threshold. At this time, as illustrated in FIG. 6, detection signal S3 is transmitted after a predetermined period has elapsed from detection D3.

When the ambient brightness is determined to be less than the brightness threshold (No in S26 in FIG. 5), controller 22 transmits the detection signal through communicator 21 (S27 in FIG. 5).

Detection D4 in FIG. 6 indicates that the ambient brightness detected by brightness detector 25 is less than the brightness threshold when detection device 20 has detected movement of a person with a magnitude greater than or equal to the threshold. At this time, as illustrated in FIG. 6, detection signal S4 is transmitted immediately after detection D4.

With operation of Variation 1 described above, when the brightness of the space where detection device 20 is provided is greater than or equal to the brightness threshold, detection device 20 delays or prunes the transmission of the detection signal even when it is determined that movement of a person with a magnitude greater than or equal to the threshold is detected in the space. With this, detection device 20 can more reliably transmit the detection signal to lighting fixture 30.

Note that, in Variation 1 of the embodiment, when the brightness detected by brightness detector 25 is greater than or equal to the brightness threshold, the transmission of the detection signal is delayed or pruned, but the detection signal may also be immediately transmitted even when the brightness detected by brightness detector 25 is less than or equal to the brightness threshold and the magnitude of the movement of the person detected by human detector 24 is less than the threshold. With such detection device 20, it is possible to immediately control lighting fixture 30 to turn on when the indoor space is dark, even when a small movement of a person is detected.

### Variation 2

Furthermore, storage 23 of detection device 20 may store a target area where detection device 20 performs detection in an indoor space, and controller 22 may delay or prune transmission of the detection signal based on the attribute of the area stored in storage 23.

For example, when detection device 20 whose target area includes the entrance of the indoor space detects movement of a person, this detection device 20 may immediately transmit a detection signal. When detection device 20 whose target area does not include the entrance of the indoor space detects movement of a person, this detection device 20 may delay or prune the transmission of the detection signal. In other words, for example, when detection device 20 whose target area is the area indicated by number 1 illustrated in FIG. 2 detects movement of a person, controller 22 may immediately transmit a detection signal even when controller 22 determines that the magnitude of the movement of the person detected by human detector 24 is less than the threshold.

Such detection device 20 immediately transmits the detection signal in an area where immediate brightening is necessary when there is a person, such as the entrance of the indoor space, and delays or prunes the transmission of the detection signal in other areas. With such operation, congestion of communication can be inhibited.

Moreover, for example, when detection device 20 whose target area includes the entrance of the indoor space detects movement of a person, controller 22 of this detection device 20 may transmit a detection signal through communicator 21 to a plurality of lighting fixtures 30 provided in the indoor space. In other words, for example, when detection device 20 whose target area is the area indicated by number 1 illustrated in FIG. 2 detects movement of a person, a plurality of lighting fixtures 30 provided in the indoor space may be controlled to be in a light-emitting state. Note that, the plurality of lighting fixtures 30 are lighting fixtures 30 that illuminate a plurality of areas, but may be all lighting fixtures 30 provided in the indoor space.

The detection signal may be transmitted to the plurality of lighting fixtures 30 from detection device 20 whose target area is an area including the entrance of the indoor space. One or more detection devices 20 and the plurality of lighting fixtures 30 may be included in a wireless mesh network, and the detection signal transmitted by detection device 20 may be relayed by different one or more detection devices 20 and one or more lighting fixtures 30 and received by lighting fixtures 30. Here, the detection signal may be transmitted through any transmission path.

When a person enters the indoor space and subsequently moves through the indoor space, the entire inside space is already in a bright state. Therefore, detection device 20 in such a case does not need to transmit the detection signal immediately. This can result in reduction in the total number of times the detection signal is transmitted and inhibit congestion of the communication.

In addition, for example, when detection device 20 detects movement of a person with a magnitude less than the threshold, controller 22 of detection device 20 delays the transmission of the detection signal for a predetermined period or reduces the frequency of the detection signal transmission, but for detection device 20 whose target area is an area in a corner of the indoor space, the predetermined period may be longer or the frequency may be lower than the predetermined period or the frequency for detection device 20 whose target area is a central area of the indoor space.

Such detection device 20 does not need to immediately transmit a detection signal in an area where immediate brightening is less necessary, such as a corner of the indoor space. Therefore, detection device 20 can inhibit congestion of communication by reducing the total number of times the detection signal is transmitted. Such detection device 20 can more reliably transmit the detection signal to a device that has a greater effect on a user.

In the embodiment described above, the device that receives a detection signal from detection device 20 is lighting fixture 30. However, the device that receives a detection signal from detection device 20 should not be construed to be limited to lighting fixture 30. The device that receives a detection signal from detection device 20 does not have to be lighting fixture 30. For example, the device may be a loudspeaker, a blower, or a fragrance generator. Lighting system 10 may be a control system including a plurality of devices instead of the plurality of lighting fixtures 30.

### Advantageous Effects, Etc.

Hereinafter, examples of techniques obtained from the present disclosure are described, and the effects and the like of the techniques described as examples will be described.

Technique 1 is detection device 20 including: human detector 24 that detects movement of a person; communicator 21 that transmits a detection signal indicating that human detector 24 has detected the movement of the person; and controller 22 that delays or prunes transmission of the detection signal by communicator 21 when controller 22 determines that a magnitude of the movement of the person detected by human detector 24 is less than a predetermined magnitude.

When such detection device 20 detects movement of a person, detection device 20 determines the magnitude of the movement of the person. When detection device 20 determines that the movement is less than or equal to a threshold, detection device 20 delays or prunes the transmission of the detection signal. With this, detection device 20 can inhibit congestion of communication for transmitting the detection signal. Therefore, detection device 20 can more reliably transmit the detection signal to a device.

Technique 2 is detection device 20 according to technique 1, wherein human detector 24 detects infrared radiation emitted by a body of the person, and when an intensity of the infrared radiation detected by human detector 24 is less than a threshold, controller 22 determines that the magnitude of the movement of the person detected is less than the predetermined magnitude.

When such detection device 20 detects movement of a person, detection device 20 can determine the magnitude of the movement of the person.

Technique 3 is detection device 20 according to technique 1 or 2 further including brightness detector 25 that detects ambient brightness, wherein controller 22 delays or prunes the transmission of the detection signal by communicator 21 based on the ambient brightness detected by brightness detector 25.

When such detection device 20 detects movement of a person, detection device 20 also detects ambient brightness, and delays or prunes the transmission of the detection signal based on the detected ambient brightness.

Technique 4 is detection device 20 according to technique 3, wherein controller 22 delays or prunes the transmission of the detection signal by communicator 21 when controller 22 determines that the magnitude of the movement of the person detected by human detector 24 is greater than or equal to the predetermined magnitude and the ambient brightness detected by brightness detector 25 is greater than or equal to a brightness threshold.

Such detection device 20 can inhibit congestion of communication for transmitting the detection signal by not immediately transmitting the detection signal when the target space where detection device 20 performs detection is sufficiently bright.

Technique 5 is detection device 20 according to any one of techniques 1 to 4, wherein controller 22 adjusts a degree of delaying or pruning the transmission of the detection signal by communicator 21 based on an attribute of a target space where detection device 20 performs detection.

Such detection device 20 can inhibit congestion of communication for transmitting the detection signal by delaying or pruning the transmission of the detection signal based on the attribute of the target space where detection device 20 performs detection. For example, detection device 20 whose target area is the innermost portion of the indoor space may delay or prune the transmission of the detection signal more frequently than detection device 20 whose target area is the central portion of the indoor space. Such detection devices 20 can more reliably transmit the detection signal to a device that has a greater effect on a user.

Technique 6 is detection device 20 according to any one of techniques 1 to 5, wherein a dimming condition of lighting fixture 30 is controlled based on the detection signal transmitted by communicator 21.

Such detection device 20 can more reliably transmit the detection signal to lighting fixture 30 by inhibiting congestion of the communication for transmitting the detection signal.

Technique 7 is detection device 20 according to technique 6, wherein when a target space where detection device 20 performs detection is a space near an entrance of an indoor space, communicator 21 transmits the detection signal to a plurality of lighting fixtures 30 provided in the indoor space, the plurality of lighting fixtures 30 each being lighting fixture 30.

When such detection device 20 detects movement of a person near the entrance of the indoor space, detection device 20 transmits the detection signal to the plurality of lighting fixtures 30 provided in the indoor space. Therefore, such detection device 20 can bring a large portion of the indoor space to a bright state at a timing when the user enters the indoor space.

Technique 8 is lighting system 10 that includes: detection device 20 according to any one of techniques 1 to 7; and lighting fixture 30 that is controlled based on the detection signal transmitted by detection device 20.

With such lighting system 10, when detection device 20 detects movement of a person, detection device 20 determines the magnitude of the movement of the person, and when detection device 20 determines that the movement is less than or equal to a threshold, detection device 20 delays or prunes the transmission of the detection signal. With this, lighting system 10 can inhibit congestion of communication for transmitting the detection signal. Therefore, detection device 10 can more reliably transmit the detection signal from detection device 20 to lighting fixture 30.

### Other Embodiments

Note that, in the embodiment described above, human detector 24 included in detection device 20 is implemented by one sensor, but may be implemented by a plurality of sensors. For example, human detector 24 may be implemented by a sensor for detecting large movements of a person and a sensor for detecting small movements of a person.

Moreover, in the embodiment described above, detection device 20 delays or prunes the transmission of the detection signal based on the magnitude of the movement of the person detected by human detector 24 and the ambient brightness detected by brightness detector 25, but may also delay or prune the transmission of the detection signal based on the ambient brightness detected by brightness detector 25 regardless of the magnitude of the movement of the person detected by human detector 24. For example, when the ambient brightness detected by brightness detector 25 is greater than or equal to the brightness threshold, the transmission of the detection signal may be delayed or pruned.

Moreover, in the embodiment described above, detection device 20 delays or prunes the transmission of the detection signal based on the magnitude of the movement of the person detected by human detector 24 and the target area where detection device 20 performs detection, but may also delay or prune the transmission of the detection signal based on the attribute of the target area where detection device 20 performs detection, regardless of the magnitude of the movement of the person detected by human detector 24. For example, when detection device 20 whose target area does not include the entrance of the indoor space detects movement of a person, this detection device 20 may transmit a detection signal with a greater degree of delay or pruning than the delay or the pruning when detection device 20 whose target area includes the entrance of the indoor space detects movement of a person.

An embodiment of the detection device and the lighting system according to the present disclosure has been described above, but the present disclosure should not be construed to be limited to the embodiment. Other embodiments obtained by making various modifications that can be conceived by a person having ordinary skill in the art to the embodiment as well as embodiments constructed by combining one or more structural elements of the one or more embodiments without departing from the spirit of the present disclosure are also encompassed within the scope of the present disclosure.

Moreover, in the embodiment described above, the lighting system is implemented by a plurality of devices. As such, the term “system” in the present description may include a plurality of devices or a single device. When a system includes a plurality of devices, the structural elements (in particular, the functional structural elements) included in the system may be distributed among the devices in any manner.

In addition, any communication method may be used between the devices in the above embodiment. In addition, communication between the devices may be performed through a relay device (such as a broadband router), which is not illustrated.

Moreover, in the embodiment described above, a process performed by a specific processor may be performed by another processor. Furthermore, the order of a plurality of processes may be changed, or a plurality of processes may be performed in parallel.

Moreover, in the embodiment described above, each structural element may be implemented by executing a software program suitable for the structural element. Each structural element may be implemented by means of a program executor such as a central processing unit (CPU) or processor loading and executing a software program recorded on a recording medium such as a hard disk or semiconductor memory.

Moreover, each structural element may be implemented by hardware. For example, each structural element may be a circuit (or integrated circuit). These circuits may form a single circuit as a whole or may be individual circuits. Moreover, these circuits may be general-purpose circuits or dedicated circuits.

Furthermore, these general and specific aspects of the present disclosure may be implemented using a system, a device, a method, an integrated circuit, a computer program, or a computer-readable recording medium, such as a compact disc read only memory (CD-ROM), or any combination of systems, devices, methods, integrated circuits, computer programs, and recording media.

For example, the present disclosure may be implemented as a control device in the above-described embodiment. Moreover, the present disclosure may be implemented as a control method to be executed by a computer such as the control system (control device) in the above-described embodiment, or a program (i.e., a computer program product) for causing the computer to execute the control method. Moreover, the present disclosure may be implemented as a non-transitory computer-readable recoding medium having such a program recorded thereon.

In addition, the present disclosure also includes embodiments obtained by applying various variations that a person ordinarily skilled in the art can conceive for each of the one or more embodiments, or embodiments implemented by arbitrarily combining the structural elements and functions of the one or more embodiments within the scope that does not materially depart from the spirit of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A detection device comprising:
a human detector that detects movement of a person;
a communicator that transmits a detection signal indicating that the human detector has detected the movement of the person; and
a controller that delays or prunes transmission of the detection signal by the communicator when the controller determines that a magnitude of the movement of the person detected by the human detector is less than a predetermined magnitude.

2. The detection device according to claim 1, wherein
the human detector detects infrared radiation emitted by a body of the person, and
when an intensity of the infrared radiation detected by the human detector is less than a threshold, the controller determines that the magnitude of the movement of the person detected is less than the predetermined magnitude.

3. The detection device according to claim 1, further comprising:
a brightness detector that detects ambient brightness, wherein
the controller delays or prunes the transmission of the detection signal by the communicator based on the ambient brightness detected by the brightness detector.

4. The detection device according to claim 3, wherein
the controller delays or prunes the transmission of the detection signal by the communicator when the controller determines that the magnitude of the movement of the person detected by the human detector is greater than or equal to the predetermined magnitude and the ambient brightness detected by the brightness detector is greater than or equal to a brightness threshold.

5. The detection device according to claim 1, wherein
the controller adjusts a degree of delaying or pruning the transmission of the detection signal by the communicator based on an attribute of a target space where the detection device performs detection.

6. The detection device according to claim 1, wherein
a dimming condition of a lighting fixture is controlled based on the detection signal transmitted by the communicator.

7. The detection device according to claim 6, wherein
when a target space where the detection device performs detection is a space near an entrance of an indoor space, the communicator transmits the detection signal to a plurality of lighting fixtures provided in the indoor space, the plurality of lighting fixtures each being the lighting fixture.

8. A lighting system comprising:
the detection device according to claim 1; and
a lighting fixture that is controlled based on the detection signal transmitted by the detection device.
